(19) United States
(12) Patent Application Publication
(10) Pub. No.: US 2026/0353439 A1
(43) Pub. Date: Nov. 5, 2026

(54) CHANNEL OCCUPANCY TIME SHARING FOR SIDELINK TRANSMISSION

(71) Applicant: Nokia Technologies Oy, Espoo (FI)

(72) Inventors: Jianguo LIU, Shanghai (CN); Timo Erkki LUNTTILA, Espoo (FI); Nuno Manuel KIILERICH PRATAS, Aalborg (DK); Ling YU, Espoo (FI); Yong LIU, Shanghai (CN); Naizheng ZHENG, Beijing (CN); Renato Barbosa ABREU, Aalborg (DK); Laura Luque SANCHEZ, Aalborg (DK); Vinh VAN PHAN, Oulu (FI); Torsten WILDSCHEK, Gloucester (GB)

(21) Appl. No.: 19/099,415

(22) PCT Filed: Aug. 5, 2022
(86) PCT No.: PCT/CN2022/110670

§ 371 Date: Jan. 28, 2025

(51) Int. Cl. H04W 74/0808; H04L 1/1829; H04W 92/18

(52) U.S. Cl. CPC H04W 74/0808; H04L 1/1854; H04W 92/18

(57) ABSTRACT

Example embodiments of the present disclosure relate to terminal devices, methods, apparatuses and a computer readable storage medium for channel occupancy time sharing for sidelink transmission. The first terminal device initiates a COT by performing an LBT procedure associated with a CAPC; transmits, to multiple terminal devices, an indication of the COT for an SL transmission among the multiple terminal devices; and detects the SL transmission during the COT. As such, the first terminal device may be aware of the information of the SL transmission (s) during the COT, and for example, the information may be used for adjusting the CW. As a result, the communication efficiency of SL transmission may be improved.

### FIELD

Example embodiments of the present disclosure generally relate to the field of telecommunication and in particular, to terminal devices, methods, apparatuses and a computer readable storage medium for channel occupancy time sharing for sidelink transmission.

### BACKGROUND

Given the scarcity and expense of bandwidth in licensed spectrum, and the increasing demand for data transmission capacity, there is increasing interest in offloading at least some communication traffic to the unlicensed spectrum. A listen before talk (LBT) is proposed, where a device intending to perform a transmission needs first to successfully complete an LBT check, before being able to initiate the transmission. LBT can also be referred as clear channel assessment (CCA).

It is proposed to study and specify support of sidelink on unlicensed spectrum (SL-U) and the sidelink enhancements are still needed to be considered.

### SUMMARY

In general, example embodiments of the present disclosure provide a solution for channel occupancy time sharing for sidelink transmission.

In a first aspect, there is provided a first terminal device. The first terminal device comprises at least one processor and at least one memory storing instructions that, when executed by the at least one processor, cause the first terminal device at least to: initiate a channel occupancy time (COT) by performing a Listen Before Talk (LBT) procedure associated with a channel access priority class (CAPC); transmit, to a plurality of terminal devices, an indication of the COT for a sidelink (SL) transmission among the plurality of terminal devices; and detect the SL transmission during the COT.

In a second aspect, there is provided a second terminal device. The second terminal device comprises at least one processor and at least one memory storing instructions that, when executed by the at least one processor, cause the second terminal device at least to: transmit traffic information to at least one of: a first terminal device or a network device; receive, from the first terminal device, an indication of a channel occupancy time (COT) initiated by the first terminal device; and transmit a sidelink (SL) transmission to a third terminal device during the COT.

In a third aspect, there is provided a network device. The network device comprises at least one processor and at least one memory storing instructions that, when executed by the at least one processor, cause the network device at least to: transmit, to a first terminal device, an initiating command indicating the first terminal device to initiate a channel occupancy time (COT), the initiating command comprising at least one of: a channel access priority class (CAPC), a plurality of identifiers of a plurality of terminal devices, traffic information of a sidelink (SL) transmission among the plurality of terminal devices, or timing information for initiating the COT.

In a fourth aspect, there is provided a method performed by a first terminal device. The method comprises: initiating, at a first terminal device, a channel occupancy time (COT) by performing a Listen Before Talk (LBT) procedure associated with a channel access priority class (CAPC); transmitting, to a plurality of terminal devices, an indication of the COT for a sidelink (SL) transmission among the plurality of terminal devices; and detecting the SL transmission during the COT.

In a fifth aspect, there is provided a method performed by a second terminal device. The method comprises: transmitting, at a second terminal device, traffic information to at least one of: a first terminal device or a network device; receiving, from the first terminal device, an indication of a channel occupancy time (COT) initiated by the first terminal device; and transmitting a sidelink (SL) transmission to a third terminal device during the COT.

In a sixth aspect, there is provided a method performed by a network device. The method comprises: transmitting, to a first terminal device, an initiating command indicating the first terminal device to initiate a channel occupancy time (COT), the initiating command comprising at least one of: a channel access priority class (CAPC), a plurality of identifiers of a plurality of terminal devices, traffic information of a sidelink (SL) transmission among the plurality of terminal devices, or timing information for initiating the COT.

In a seventh aspect, there is provided an apparatus. The apparatus comprises: means for initiating, at a first terminal device, a channel occupancy time (COT) by performing a Listen Before Talk (LBT) procedure associated with a channel access priority class (CAPC); means for transmitting, to a plurality of terminal devices, an indication of the COT for a sidelink (SL) transmission among the plurality of terminal devices; and means for detecting the SL transmission during the COT.

In an eighth aspect, there is provided an apparatus. The apparatus comprises: means for transmitting, at a second terminal device, traffic information to at least one of: a first terminal device or a network device; means for receiving, from the first terminal device, an indication of a channel occupancy time (COT) initiated by the first terminal device; and means for transmitting a sidelink (SL) transmission to a third terminal device during the COT.

In a ninth n aspect, there is provided an apparatus. The apparatus comprises: means for transmitting, to a first terminal device, an initiating command indicating the first terminal device to initiate a channel occupancy time (COT), the initiating command comprising at least one of: a channel access priority class (CAPC), a plurality of identifiers of a plurality of terminal devices, traffic information of a sidelink (SL) transmission among the plurality of terminal devices, or timing information for initiating the COT.

In a tenth aspect, there is provided a non-transitory computer readable medium comprising program instructions for causing an apparatus to perform at least the method in any of the fifth to the eighth aspects.

In an eleventh aspect, there is provided a computer program comprising instructions, which, when executed by an apparatus, cause the apparatus at least to perform the method in any of the fifth to the eighth aspects.

In a twelfth aspect, there is provided a first terminal device. The first terminal device comprises: initiating circuitry configured to initiate a COT by performing an LBT procedure associated with a CAPC; transmitting circuitry configured to transmit, to a plurality of terminal devices, an indication of the COT for an SL transmission among the plurality of terminal devices; and detecting circuitry configured to detect the SL transmission during the COT.

In a thirteenth aspect, there is provided a second terminal device. The second terminal device comprises: transmitting circuitry configured to transmit traffic information to at least one of: a first terminal device or a network device; receiving circuitry configured to receive, from the first terminal device, an indication of a COT initiated by the first terminal device; and transmitting circuitry configured to transmit an SL transmission to a third terminal device during the COT.

In a fourteenth aspect, there is provided a network device. The network device comprises: transmitting circuitry configured to transmit, to a first terminal device, an initiating command indicating the first terminal device to initiate a channel occupancy time (COT), the initiating command comprising at least one of: a channel access priority class (CAPC), a plurality of identifiers of a plurality of terminal devices, traffic information of a sidelink (SL) transmission among the plurality of terminal devices, or timing information for initiating the COT.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIGS. 1B and 1C illustrate two examples scenarios in which some example embodiments of the present disclosure may be implemented;

FIG. 2A illustrates an example diagram of CCA slot in which some example embodiments of the present disclosure may be implemented;

FIG. 2B illustrates an example diagram of acquisition of the COT by an initiating device via type 1 LBT in which some example embodiments of the present disclosure may be implemented;

FIG. 3A illustrates some example of type 1 LBT CW countdown procedure in which some example embodiments of the present disclosure may be implemented;

FIG. 3B illustrates some example of allowed gaps for type 2 LBT in which some example embodiments of the present disclosure may be implemented;

FIG. 3C illustrates an example of a relation between LBT bandwidth and sub-channel bandwidth for SL-U in which some example embodiments of the present disclosure may be implemented;

FIG. 4A illustrates an example of a process flow in accordance with some example embodiments of the present disclosure;

FIG. 4B illustrates another example of a process flow in accordance with some example embodiments of the present disclosure;

FIG. 5 illustrates another example of a process flow in accordance with some example embodiments of the present disclosure;

FIG. 6 illustrates an example frame structure in accordance with some example embodiments of the present disclosure;

FIG. 7 illustrates a flowchart of a method implemented at a first terminal device in accordance with some example embodiments of the present disclosure;

FIG. 8 illustrates a flowchart of a method implemented at a second terminal device in accordance with some example embodiments of the present disclosure;

FIG. 9 illustrates a flowchart of a method implemented at a network device in accordance with some example embodiments of the present disclosure;

FIG. 10 illustrates a simplified block diagram of a device that is suitable for implementing some example embodiments of the present disclosure; and

FIG. 11 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In release 18, it is proposed to study and specify support of sidelink on unlicensed spectrum. The following text box describes some non-restrictive introduction information of the SL-U that may be used in some example embodiments of the present disclosure.

R18 work item (RP-213678)

2. Study and specify support of sidelink on unlicensed spectrum for both mode 1 and
mode 2 where Uu operation for mode 1 is limited to licensed spectrum only
[RAN1, RAN2, RAN4]

| | |
|---|---|
| - | Channel access mechanisms from NR-U shall be reused for sidelink |
| | unlicensed operation |

| | |
|---|---|
| ∘ | Assess the applicability of sidelink resource reservation from |
| | Rel-16/Rel-17 to sidelink unlicensed operation within the boundaries of |
| | unlicensed channel access mechanism and operation |

| | |
|---|---|
| ▪ | No specific enhancements for Rel-17 resource allocation |
| | mechanisms |
| ▪ | If the existing NR-U channel access framework does not support |
| | the required SL-U functionality, WGs will make appropriate |
| | recommendations for RAN approval. |

| | |
|---|---|
| - | Physical channel design framework: Required changes to NR sidelink |
| | physical channel structures and procedures to operate on unlicensed |
| | spectrum |

| | |
|---|---|
| ∘ | The existing NR sidelink and NR-U channel structure shall be reused as |
| | the baseline. |

| | |
|---|---|
| - | No specific enhancements for existing NR SL feature |
| - | The study should focus on FR1 unlicensed bands (n46 and n96/n102) and is |
| | to be completed by RAN#98. |

In sub-7 GHz unlicensed bands, the new radio (NR) coexistence with other systems (such as the Institute of Electrical and Electronics Engineers (IEEE) 802.11) is ensured via an LBT channel access mechanism. A user equipment (UE) intending to perform a sidelink (SL) transmission needs first to successfully complete an LBT check, before being able to initiate that same transmission, where the UE may be called as an SL UE in some embodiments.

For unlicensed band operation, the SL UE could either acquire the “right” to access the channel via Type-1 LBT by itself for a certain period of time, denoted as the channel occupancy time (COT) (in other words, to initiate the COT) for an SL transmission, or be shared a COT initiated by another UE to acquire the channel via “reduced” LBT procedure (e.g., Type 2 LBT) for an SL transmission. Obviously, the “reduced” LBT (i.e., Type 2A/2B/2C LBT) procedure will be friendly to SL UE (e.g., sensor device, low cost MTC device, or even low cost terminal device) from aspects of power consumption, latency and capability requirement. For this, it makes sense if a device with at least Type 1 LBT capability can initiate a COT and then share the COT to other SL UEs for SL transmission in the unlicensed band.

Example embodiments of the present disclosure provide a solution for SL-U. Especially, a first terminal device may initiate a COT by performing an LBT procedure associated with a channel access priority class (CAPC), share the COT with other terminal devices and further detect sidelink transmission(s) during the COT. As such, the first terminal device may be aware of the information of the SL transmission(s) during the COT, and for example, the information may be used for adjusting CW. As a result, the communication efficiency of SL transmission may be improved. Principles and some example embodiments of the present disclosure will be described in detail below with reference to the accompanying drawings.

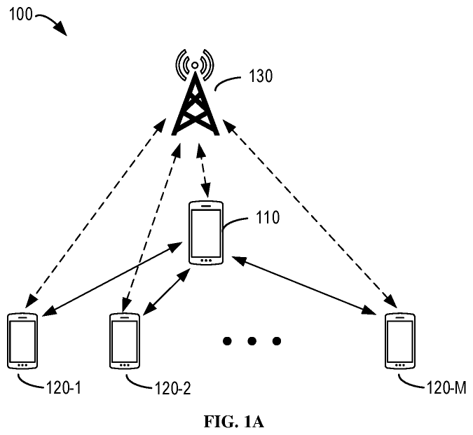

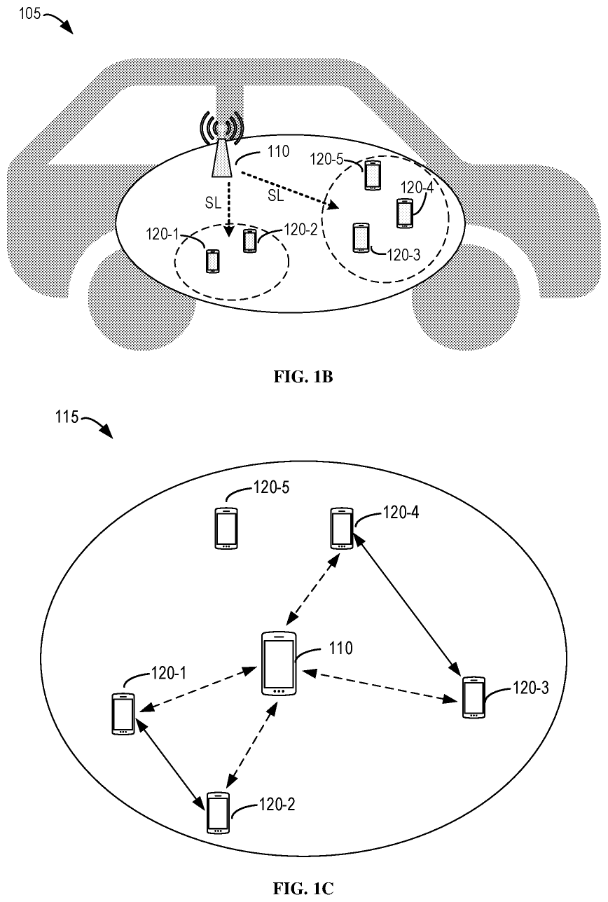

FIG. 1A illustrates an example of a network environment 100 in which some example embodiments of the present disclosure may be implemented. The network environment 100 may include a first terminal device 110, multiple terminal devices 120, and a network device 130. The network device 130 may provide a wireless access cell through which each of the first terminal device 110 and the multiple terminal devices 120 may communicate with the network device 130. In some example embodiments, the network device 130 can be a gNB that provides 3GPP NR cell. In other example embodiments, the network device 130 may be an eNB that provides an LTE cell. The air interfaces over which the first terminal device 110, the multiple terminal devices 120 and the network device 130 communicate may be compatible with 3GPP technical specifications, such as those that define Fifth Generation (5G) NR system standards.

As depicted in FIG. 1A, the multiple terminal devices 120 include a terminal device 120-1, a terminal device 120-2, . . . , and a terminal device 120-M. It is noted that the number M can be any suitable natural number. It is to be understood that the number of network devices and terminal devices is only for the purpose of illustration without suggesting any limitations. The network environment 100 may include any suitable number of network devices and terminal devices adapted for implementing embodiments of the present disclosure. It is noted that some example embodiments of the present disclosure can be implemented without the presence of the network device 130.

The first terminal device 110 and the multiple terminal devices 120 may also communicate directly with one another over a sidelink interface. The sidelink interface may alternatively be referred to as a ProSe interface, device-to-device (D2D) interface, user-to-user (U2U) interface, or a ProSe communication 5 (PC5) interface. In some example embodiments, the network environment 100 may be deployed within a vehicular communication system. In a vehicular communication system, the first terminal device 110 and the multiple terminal devices 120 may communicate with one another using cellular vehicle-to-everything (V2X) communications. V2X may involve vehicle-to-vehicle (V2V), vehicle-to-infrastructure (V2I), vehicle-to-network (VTN), or vehicle-to-pedestrian (V2P) communications. Thus, while FIG. 1A depicts the first terminal device 110 and the multiple terminal devices 120 as mobile phones, the first terminal device 110 and the multiple terminal devices 120 may be any type of user equipment.

In some example embodiments, the transmission link between the first terminal device 110 and any of the multiple terminal devices 120 may be denoted as a sidelink (SL).

It is to be understood that the network environment 100 shown in FIG. 1A is only for the purpose of illustration without suggesting any limitation as to the scope of the disclosure. For example, in other embodiments, the first terminal device 110 may be replaced by another network device, such as a base station.

Communications in the network environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the following descriptions, the first terminal device 110 may be taken as a head device of the multiple terminal devices 120. In some example embodiments, the first terminal device 110 may be referred to as a cluster head (CH) device, and the multiple terminal devices 120 may be referred to as cluster member (CM) devices. In some embodiments, the multiple terminal devices 120 may be divided into one or more clusters according to a cluster configuration from the network device 130. In some embodiments, the first terminal device 110 and the multiple terminal devices 120 may be within the coverage of the network device 130.

FIG. 1B illustrates an example of a network environment 105 in which some example embodiments of the present disclosure may be implemented. The network environment 105 may include a first terminal device 110 and terminal devices 120-1 to 120-5. As shown in FIG. 1B, the first terminal device 110 and the terminal devices 120-1 to 120-5 are located within a car. There are two clusters shown in FIG. 1B, where the first cluster includes the terminal devices 120-1 and 120-2, and the second cluster includes the terminal devices 120-3 to 120-5.

In some example embodiments, the first terminal device 110 (CH device) may be responsible for the LBT clearance to acquire the COT for the multiple terminal devices 120-1 to 120-5 (i.e., one or more group of CM devices) as targeted for in-car SL communication scenario. In some examples, each of the multiple terminal devices 120-1 to 120-5 may be a sensor device, a low cost MTC device, or a low-cost UE terminal device. In some examples, each of the multiple terminal devices 120-1 to 120-5 may have capability limitation of LBT operation. For example, only type 2 LBT (e.g., Type 2C LBT) is supported for cost reduction at the multiple terminal devices 120-1 to 120-5.

It is to be understood that the network environment 105 shown in FIG. 1B is only for the purpose of illustration without suggesting any limitation as to the scope of the disclosure. For example, in other embodiments, there may be a network device 130.

For example, the first terminal device 110 and the multiple terminal devices 120 may be located in other scenarios. As a non-limited example, the first terminal device 110 may be a device with smart-home technology, such as an air-conditioner or a fridge in home, may have the LBT capability and may act as a CH device. The multiple terminal devices 120 may be sensors installed in home window-curtains. In some examples, the first terminal device 110 may be responsible for acquiring the unlicensed channel access for the multiple terminal devices 120, such as sensors for opening/closing the home window-curtains.

FIG. 1C illustrates an example of a network environment 115 in which some example embodiments of the present disclosure may be implemented. The network environment 115 may include a first terminal device 110 and terminal devices 120-1 to 120-5. As shown in FIG. 1C, it is assumed that a data transmission may be performed between the terminal device 120-1 and 120-2, another data transmission may be performed between the terminal device 120-3 and 120-4, which are denoted as solid lines in FIG. 1C. Additionally, there may be control signaling from the first terminal device 110 to any of the terminal devices 120-1 to 120-4, which are denoted as dash lines in FIG. 1C.

In some example embodiments, the transmission channel between two different terminal devices may be any of: physical sidelink control channel (PSCCH), physical sidelink shared channel (PSSCH), or physical sidelink feedback channel (PSFCH).

It is to be understood that the network environment 115 shown in FIG. 1C is only for the purpose of illustration without suggesting any limitation as to the scope of the disclosure. For example, in other embodiments, there may be a network device 130. For example, in other embodiments, there may be data transmissions from the first terminal device 110 to one of the terminal devices 120-1 to 120-5.

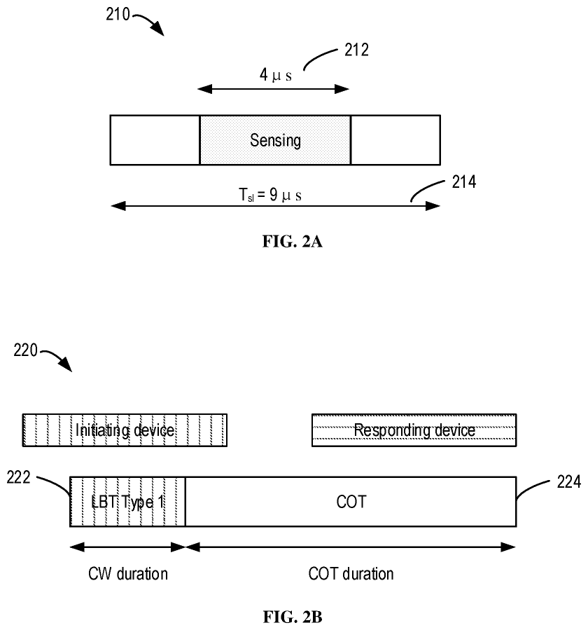

For a terminal device to pass an LBT check, it needs to observe the channel as available for a number of consecutive durations. The total duration of consecutive durations may be called as a contention window (CW) duration. One of the durations within the CW duration may be called as a CCA slot or a sensing slot, and the length of the CCA slot may be denoted as Tₛₗ. FIG. 2A illustrates an example diagram 210 of CCA slot in sub-7 GHz. As shown in FIG. 2A, the length of the CCA slot 214 is Tₛₗ=9 μs.

In some example embodiments, the terminal device may deem the channel as available in a CCA slot, if the measured power is below a regulatory specified threshold. With reference to FIG. 2A, the terminal device may measure the power within a duration 212 (such as 4 μs in FIG. 2A), and the terminal device may determine that the channel is available if the measured power is below the threshold. In some embodiments, the threshold may depend on the operating band and/or the geographical region, and the present disclosure does not limit this aspect.

In the context of the disclosure, the term “initiating device” may be a device initiates a COT for a sidelink transmission using Type 1 LBT procedure, and the term “responding device” may be a device shares the COT for sidelink transmission using a reduced LBT type. In the context of the disclosure, the term “sidelink (SL) transmission” and “SL communication” may be used interchangeably. In the context of the disclosure, the term “type 1 LBT” may also be called as LBT type 1, extended LBT or the like, and the term “type 2 LBT” may also be called as LBT type 2, reduced LBT or the like. In some embodiments, the extended LBT and the reduced LBT may refer to those described in TS 37.213 and will not be repeated herein.

When a terminal device (initiating device) initiates the communication, the terminal device may perform a type 1 LBT so as to acquire a right to access the channel for a certain period of time, i.e., to initiate the COT. FIG. 2B illustrates an example diagram 220 of acquisition of the COT by an initiating device via type 1 LBT. As shown in FIG. 2B, the initiating device may perform a type 1 LBT during a CW duration 222, and the communication may be performed during the following COT 224.

In some example embodiments, the maximum duration of the COT and the size of the CW duration may depend on the Channel Access Priority Class (CAPC) associated with the terminal device's traffic, as shown in Table 1. In some embodiments, control plane traffic (such as PSCCH) is transmitted with p=1, while user plane traffic has p>1.

TABLE 1

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

The detailed description of Table 1 may refer to “Table 4.2.1-1: Channel Access Priority Class (CAPC) for UL” in TS. 37.213 and thus will not be repeated herein. In some examples, the size of the CW duration may refer to a number of CCA slots within the CW duration, for example, the size of the CW duration may be denoted as N, which is an integer. In some examples, the size of the CW duration may be called as a size of CW, CW size, or CW for short. It is understood that the CW in CCA slots associated with each CAPC may have a minimum value (CW_{min,p}) and a maximum value (CW_{max,p}), and the duration of COT may be given by T_{ulm,cot,p} in Table 1. Table 1 depicts the Type 1 LBT details for the Uu uplink (UL) case, which may be adopted in SL. However, it is to be understood that the downlink (DL) case Type 1 LBT parameters or any other parameters could also be adopted in SL, which will not be repeated herein.

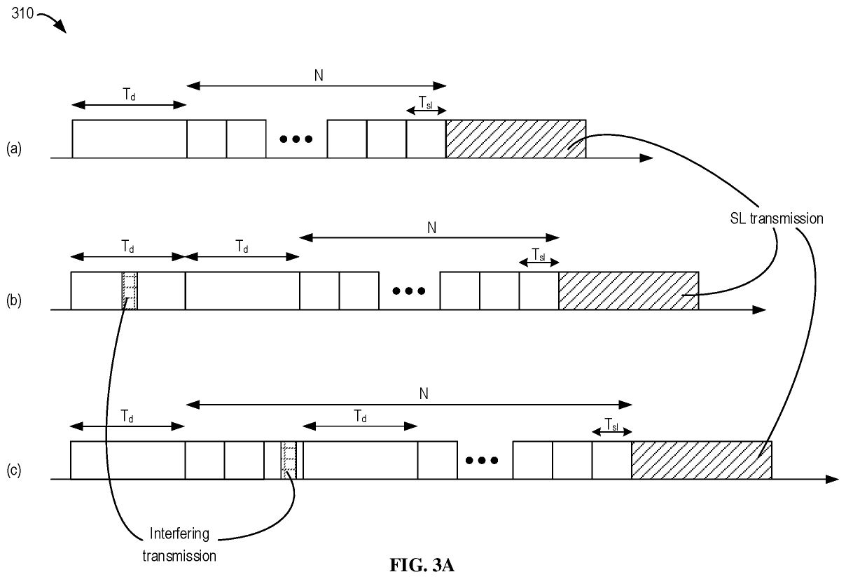

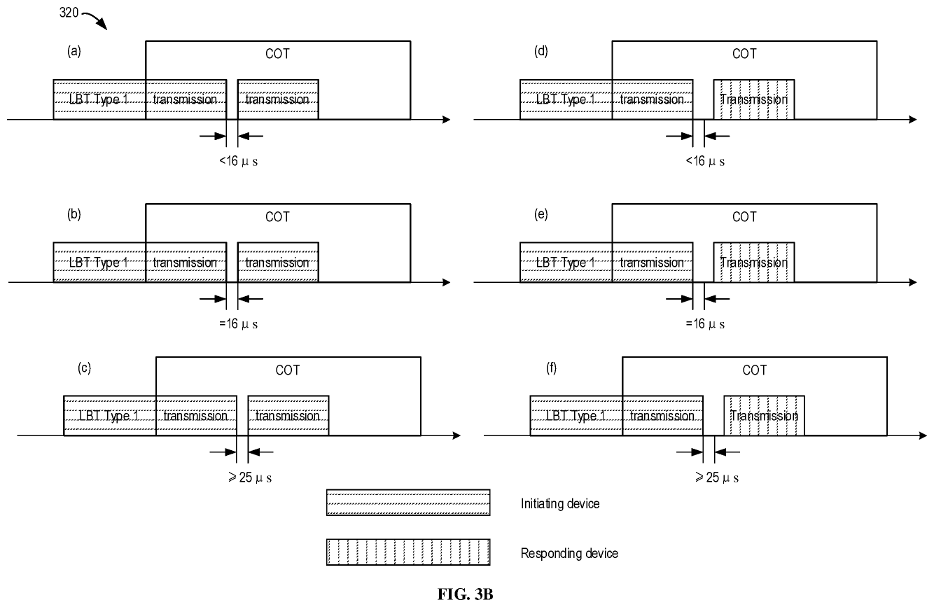

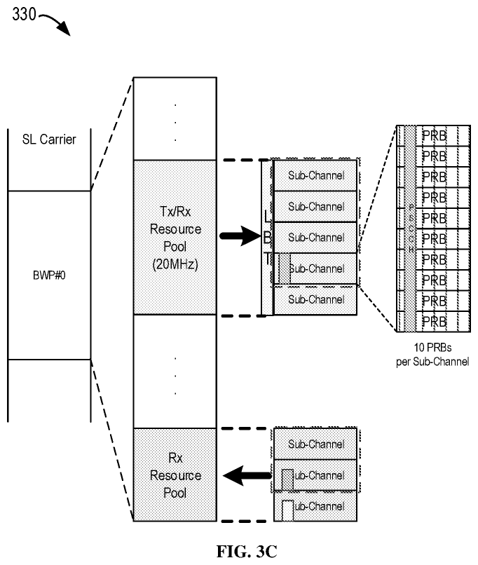

FIG. 3A illustrates some example of type 1 LBT CW countdown procedure 310 in which some example embodiments of the present disclosure may be implemented. In some example embodiments, as shown in (a) in FIG. 3A, if the channel is detected as free during a defer time (denoted as T_{d}), the CW countdown procedure is performed. When neither the defer time nor the countdown is disrupted (i.e., the channel is not detected as busy during a sensing slot), the type 1 LBT is finished and the SL transmission may be followed. In some example embodiments, as shown in (b) in FIG. 3A, if the defer time is disrupted, i.e., the channel is detected as busy during a defer time sensing slot, then another defer time is further detected until it is free. In some example embodiments, as shown in (c) in FIG. 3A, if the channel is detected as free during a defer time and the countdown is disrupted, i.e., the channel is detected as busy during a sensing slot of the countdown (the LBT check fails in a CCA slot (Tₛₗ)), then the countdown will stop and will resume if the channel is deemed as free during another defer time. In some embodiments, N in FIG. 3A refers to a number of CCA slots required to be deemed as free before the contention window countdown is complete.

In NR-U, a terminal device shall maintain the contention window value CWₚ and may adjust CWₚ for its transmissions before the Type 1 LBT procedure associated with channel access priority class p. In some embodiments, the terminal device may adjust CWₚ based on the success or failure of reception of the PUSCH(s) (such as the UL HARQ-ACK feedback) within the pervious COT as specified in TS37.213.

In some embodiments, upon successfully completing the Type 1 LBT, the initiating device may acquire the COT with a maximum duration associated with the corresponding CAPC, and thus the initiating device may perform a transmission. In some embodiments, the acquired COT is still valid even if the initiating device pauses its transmission. In some embodiments, if the initiating device would like to perform a new transmission within the acquired COT, it is still required to perform a reduced LBT procedure.

In some example embodiments, the initiating device may share the acquired COT with its intended receiver(s) i.e. the responding device(s). For this purpose, the initiating device shall inform (e.g. via control signaling) the responding device about the remaining duration of the COT. If the responding device intends to perform a transmission with the initiating device, it may decide which type of LBT it should apply based on the shared COT from the initiating device. In some examples, if the intended transmission of the responding device falls within the COT, a reduced LBT may be performed by the responding device.

FIG. 3B illustrates some example of allowed gaps for type 2 LBT 320 in which some example embodiments of the present disclosure may be implemented. In FIG. 3B, (a), (b), and (c) show the cases where the gap is between the two transmissions both from the initiating UE, while (d), (e), and (f) show the cases where the gap is between the two different transmissions from the initiating UE and the responding UE respectively.

In some other example embodiments, the reduced LBT may also be called as type 2 LBT, and may include type 2A LBT, type 2B LBT and type 2C LBT:
Type 2A (25 μs LBT)—for SL transmissions within the acquired COT (an SL transmission following another SL transmission) in case the gap between two SL transmissions is ≥25 μs, as depicted in (c) and (f) in FIG. 3B;
Type 2B (16 μs LBT)—for SL transmissions within the acquired COT (an SL transmission following another SL transmission) in case the gap exactly equals to 16 μs, as depicted in (b) and (e) in FIG. 3B;
Type 2C (no LBT)—for SL transmissions within the acquired COT (an SL transmission following another SL transmission) in case the gap<16 μs and the allowed duration of the SL transmission≤584 μs, as depicted in (a) and (d) in FIG. 3B.

In some other example embodiments, if the intended following transmission falls outside the acquired COT, another Type 1 LBT should be performed to acquire a new COT.

In some example embodiments, for a single carrier operation of SL in release 16 or release 17, a terminal device will make its resource selection based on a sensing result with a resource pool (RP) for resource allocation (RA) mode-2. In some examples, the RP may be further divided into sub-channels in frequency domain, and each sub-channel may consist of consecutive non-overlapping set of at least 10 physical resource blocks (PRBs) in a slot. In some embodiments, the resource allocation, the sensing and the resource selection of SL RA mode-2 may be performed in units of sub-channels.

In some example embodiments, the LBT bandwidth in frequency domain is typically 20 MHz in release-16 NR-U. In some embodiments, the 20 MHz LBT bandwidth may correspond to the RP bandwidth with multiple sub-channels for SL operation in unlicensed spectrum. FIG. 3C illustrates an example of a relation 330 between LBT bandwidth and sub-channel bandwidth for SL-U in which some example embodiments of the present disclosure may be implemented. As shown in FIG. 3C, there are 5 sub-channels configured within a transmitter/receiver (TX/RX) RP, and each sub-channel may consist of 10 PRBs, by assuming the sub-carrier space (SCS) is 30 kHz.

Furthermore, the multiple sub-channels may be allocated to different terminal devices for SL communication.

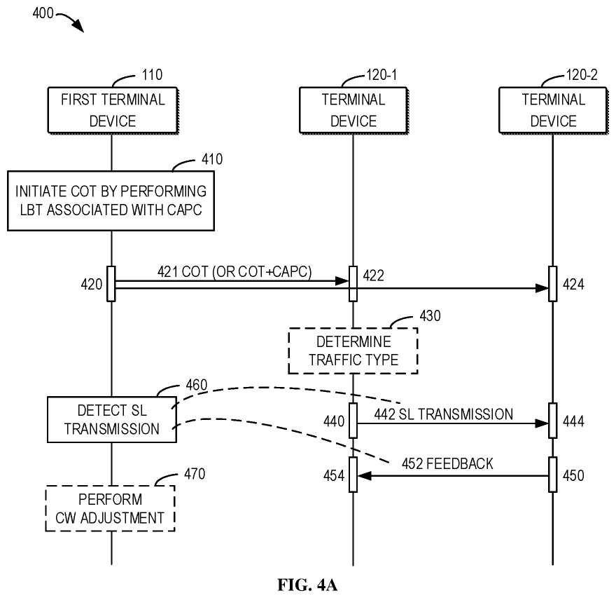

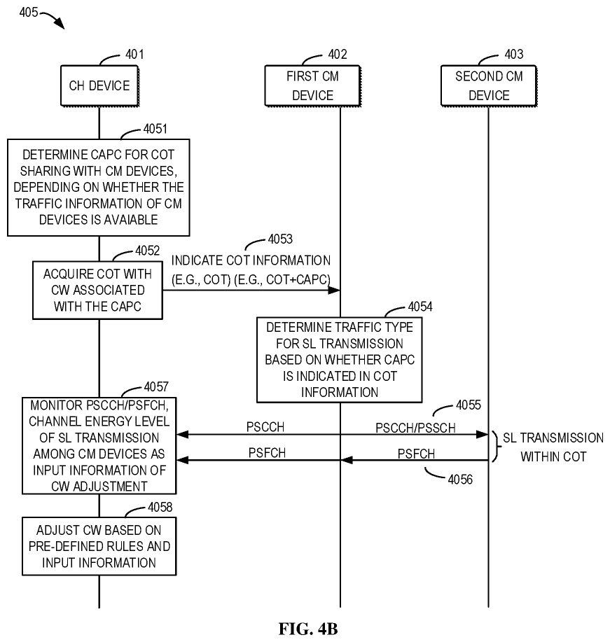

Based on the description above, for unlicensed band operation, a terminal device may acquire a channel via a type 1 LBT by itself to initiate a COT, or the terminal device may acquire a channel via a type 2 LBT within a COT shared by another terminal device. It is understandable that type 2 LBT would be preferable for a terminal device from aspects of power consumption, latency and capability requirement. Principles and some example embodiments of the present disclosure will be described in detail below with reference to FIGS. 4-10.

FIG. 4A illustrates an example of a process flow 400 in accordance with some example embodiments of the present disclosure. For the purpose of discussion, the process flow 400 will be described with reference to FIG. 1A. The process flow 400 involves a first terminal device 110, a terminal device 120-1 and a terminal device 120-2. In some embodiments, the terminal device 120-1 may be called as a second terminal device and the terminal device 120-2 may be called as a third terminal device. It would be appreciated that although the process flow 400 has been described in the network environment 100 of FIG. 1A, this process flow may be likewise applied to other communication scenarios.

In the process flow 400, the first terminal device 110 initiates 410 a COT by performing an LBT procedure associated with a CAPC. In some embodiments, the LBT procedure may be a type 1 LBT procedure, or also be called as a type 1 LBT. In some embodiments, the first terminal device 100 has a type 1 LBT capability.

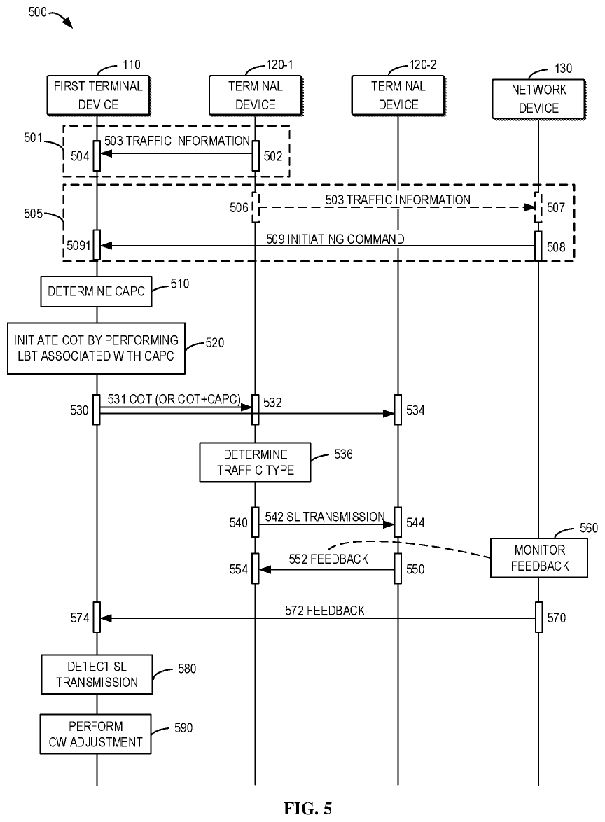

In some example embodiments, the first terminal device 110 may receive an initiating command from the network device 130, and initiate the COT based on the initiating command. The detailed description may refer to those discussed with reference to FIG. 5 below.

In some example embodiments, the CAPC may be a fixed CAPC. In some examples, the CAPC may be pre-defined at the first terminal device 110. In some other examples, the CAPC may be pre-configured by the network device 130. For example, the network device 130 may determine the CAPC during cluster configuration and transmit the CAPC to the first terminal device 110.

In some examples, the pre-defined or pre-configured CAPC may be a lowest CAPC from a plurality of pre-configured CAPCs. As such, the first terminal device 110 may always give prioritized access to terminal devices 120.

In some examples, the pre-defined or pre-configured CAPC may be a highest CAPC from a plurality of pre-configured CAPCs. As such, the first terminal device 110 may give lower (comparing with a lowest CAPC) priority access to terminal devices 120, but the initiated COT may be longer.

In some example embodiments, the CAPC may be determined based on traffic information. For example, the CAPC may be determined by the first terminal device 110 or may be determined by the network device 130.

In some examples, at least one of the terminal devices 120 may transmit the traffic information to the first terminal device 110, accordingly the first terminal device 110 may receive the traffic information from at least one of the terminal devices 120, and the first terminal device 110 may determine the CAPC based on the received traffic information.

In some other examples, at least one of the terminal devices 120 may transmit the traffic information to the network device 130, accordingly the network device 130 may receive the traffic information from at least one of the terminal devices 120. The network device 130 further transmits the traffic information to the first terminal device 110, accordingly the first terminal device 110 may receive the traffic information and may determine the CAPC based on the received traffic information.

In some other examples, the network device 130 may determine the traffic information based on the categories of the multiple terminal devices 120, for example during the cluster configuration. The network device 130 may transmit the determined traffic information to the first terminal device 110, accordingly the first terminal device 110 may receive the traffic information and may determine the CAPC based on the received traffic information.

In some embodiments, the first terminal device 110 may determine the CAPC based on the received traffic information and further based on one or more of: channel load, anticipated COT.

In some other examples, at least one of the terminal devices 120 may transmit the traffic information to the network device 130, accordingly the network device 130 may receive the traffic information from at least one of the terminal devices 120 and further the network device 130 may determine the CAPC based on the received traffic information. The network device 130 may further transmit the determined CAPC to the first terminal device 110, accordingly the first terminal device 110 may receive the CAPC.

In some other examples, the network device 130 may determine the traffic information based on the categories of the multiple terminal devices 120, for example during the cluster configuration. The network device 130 may determine the CAPC based on the determined traffic information. The network device 130 may further transmit the determined CAPC to the first terminal device 110, accordingly the first terminal device 110 may receive the CAPC.

In some example embodiments, the CAPC may be determined by the first terminal device 110. In some examples, the first terminal device 110 may select the CAPC from a plurality of pre-configured CAPCs.

For example, the selected CAPC may be a highest CAPC from the plurality of pre-configured CAPCs. In some examples, if the first terminal device 110 doesn't know the traffic information of the multiple terminal devices 120, the first terminal device 110 may select the highest CAPC.

In some embodiments, the plurality of pre-configured CAPCs may include 1, 2, 3, and 4 as described in Table 1. In some embodiments, the traffic information transmitted from at least one of the terminal device 120 to the first terminal device 110 may be carried in a buffer state report (BSR). In some embodiments, the traffic information may indicate traffic type (or types) associated with categories of the multiple terminal devices 120.

In some embodiments, there may be a default CAPC stored (or pre-defined, or pre-configured) at the first terminal device 110. In some embodiments, there may be a same default CAPC at the multiple terminal devices 120.

In some example embodiments, the first terminal device 110 may initiate (or determine) the COT. In some examples, the first terminal device 110 may determine a maximum COT and a size of CW (between a minimum contention window, a maximum contention window) based on the CAPC; and the first terminal device 110 may perform the type 1 LBT based on the CW, to initiate the COT.

In the process flow 400, the first terminal device 110 transmits 420 an indication of the COT 421 to the multiple terminal devices 120, including terminal device 120-1 and terminal device 120-2 as shown in FIG. 4A. As such, the terminal device 120-1 may receive 422 the indication of the COT 421, and the terminal device 120-2 may receive 424 the indication of the COT 421.

In some embodiments, the indication of the COT 421 may be transmitted through control signaling, such as sidelink control information (SCI) or a sequence-based signaling.

Alternatively or in addition, the first terminal device 110 may transmit an indication of the CAPC to the multiple terminal devices 120. In some embodiments, the indication of the CAPC may be transmitted through control signaling. In some embodiments, the indication of the COT and the indication of the CAPC may be carried in same signaling.

In some example embodiments, the indication of CAPC may not be transmitted from the first terminal device 110 to the multiple terminal devices 120. In some examples, if the CAPC determined by the first terminal device 110 is the same as the default CAPC, then the CAPC may not be indicated, as such, the signaling overhead may be reduced.

In some example embodiments, it is assumed that there is SL transmission to be initiated by the terminal device 120-1. Alternatively or in addition, the terminal device 120-1 may determine 430 the traffic type of the SL transmission to be performed during the COT.

In some embodiments, if the indication of CAPC is transmitted, the terminal device 120-1 may determine the traffic type of the SL transmission to be performed based on the indicated CAPC.

In some embodiments, if there is no indication of CAPC in transmitted from the first terminal device 110, the terminal device 120-1 may determine a default (or a pre-defined or pre-configured) CAPC, and further determine the traffic type of the SL transmission to be performed based on the default CAPC.

In the process flow 400, the terminal device 120-1 transmits 440 the SL transmission 442 to the terminal device 120-2 during the COT. On the other side of communication, the terminal device 120-2 receives 444 the SL transmission 442. Specifically, the terminal device 120-1 may transmit the SL transmission 442 based on the resource selection and the indicated COT.

In some example embodiments, the SL transmission 442 performed within the COT may be limited with the traffic type determined at 430. In some example embodiments, the SL transmission 442 within the COT may be limited to groupcast and/or unicast transmission, the present disclosure does not limit this aspect. In some example embodiments, the SL transmission 442 may be transmitted through PSCCH or PSSCH, and the present disclosure does not limit this aspect.

The terminal device 120-2 transmits 450 feedback information 452 of the SL transmission to the terminal device 120-1. Accordingly, the terminal device 120-1 receives 454 the feedback information 452. In some example embodiments, the feedback information 452 may be transmitted through PSCCH or PSFCH.

Alternatively or in addition, the terminal device 120-1 or the terminal device 120-2 may perform a further SL transmission after a type 2 LBT procedure within the indicated COT.

As such, the first terminal device 110 with at least type 1 LBT capability may initiate the COT, and the COT may be shared to other terminal devices 120 for the SL transmission in the unlicensed band. Thus, there is no need for the terminal devices 120 to perform type 1 LBT and the power consumption at the terminal devices 120 may be reduced.

Continue referring to FIG. 4A, the first terminal device 110 detects 460 the SL transmission during the COT. In some example embodiments, the first terminal device 110 may detect the SL transmission and determine a detection result.

In some example embodiments, the detection result may include one or more of: SCI associated with the SL transmission, HARQ feedback information of the SL transmission, or a channel energy level of the SL transmission. Alternatively or in addition, the first terminal device 110 may determine input information at least based on the detection result, where the input information may be used for CW adjustment.

In some embodiments, the first terminal device 110 may monitor the SL transmission (PSCCH and/or PSFCH) within the COT. In some examples, the first terminal device 110 may monitor the intra-cluster SCI exchange (i.e., the PSCCH) based on identifiers (ID) of the terminal devices 120. For example, the first terminal device 110 may detect whether the terminal devices 120 are able to transmit during the COT, and the first terminal device 110 may further take the detection information in the SCI as part of the input information.

In some embodiments, the first terminal device 110 may detect the resource allocation of the SL transmission (PSSCH) of the terminal devices 120 within the COT. In some embodiments, the first terminal device 110 may monitor the HARQ feedback information (PSFCH) based on the resource allocation. In some examples, the first terminal device 110 may take the HARQ feedback information as part of the input information.

In some embodiments, the first terminal device 110 may detect the channel energy level by sensing a channel at a predetermined time. In some examples, the first terminal device 110 may sense the channel the detected the energy level during the COT and take the detected energy level as part of input information. For example, by detecting energy in the channel at a predetermined time, the first terminal device 110 may determine whether a terminal device (such as the terminal device 120-2) successfully receives the SL transmission 442. In other words, the detected energy may implicitly indicate whether the SL transmission 442 is successful.

Alternatively or in addition, the first terminal device 110 performs 470 a CW adjustment based on the input information. In some embodiments, the first terminal device 110 may adjust the CW associated with the CAPC according to at least one pre-defined rules.

In some embodiments, the first terminal device 110 may reset the size of the CW to an initial value based on one or more of: a number of acknowledges (ACKs) indicated by the HARQ feedback information exceeding a threshold of ACK number, a ratio of the number of ACKs to a total feedback number indicated by the HARQ feedback information exceeding a threshold of ACK ratio, a number of terminal devices transmitting the SCI exceeding a threshold of device number, or a ratio of the number of terminal devices transmitting the SCI to a number of the plurality of terminal devices exceeding a threshold of device ratio.

In some examples, the threshold of ACK number is denoted as NO (an integer, such as 1), the threshold of ACK ratio is denoted as x % (such as 10%). As such, if at least NO HARQ feedbacks or x % of the HARQ feedbacks are “ACK” for PSSCH transmissions within the COT, the first terminal device 110 may reset the size of the CW.

In some examples, the first terminal device 110 may determine a change of detected channel energies before and after a predefined time within the COT, and determine that the feedback information indicates ACK if the change exceeds a threshold of energy detection. In some examples, the first terminal device 110 may determine that an “ACK” is detected if no NACK is detected in case of NACK only feedback.

In some examples, the threshold of device number is denoted as M0 (an integer, such as 1), the threshold of device ratio is denoted as y % (such as 10%). As such, if at least M0 anticipated devices among the multiple terminal devices 120 or y % of the anticipated devices are detected to transmit SCI within the COT, the first terminal device 110 may reset the size of the CW. In some examples, for a specific terminal device (such as terminal device 120-2), the first terminal device 110 may determine whether the terminal device 120-2 is an anticipated device based on monitored SCI of the terminal device 120-2, and/or the BSR from the terminal device 120-2.

In some embodiments, the first terminal device 110 may increase the size of the CW based on one or more of: no SCI being detected, no HARQ feedback being detected, a number of detected SCIs being below a threshold of SCIs, a number of detected HARQ feedbacks being below a threshold of feedbacks, or a ratio of a time period in which the channel energy level being above a threshold to the COT exceeding a threshold of time ratio. For example, the threshold of SCIs may be denoted as N1, the threshold of feedbacks may be denoted as N2, and the threshold of time ratio may be denoted as z %. In some examples, no SCI is detected may refer to that no SL transmission is performed.

In other words, the first terminal device 110 may increase the CW if at least one of the following conditions is satisfied: no HARQ feedback for SL transmission(s) of the multiple terminal devices 120 during the COT; no SL transmission is detected through SCI during the COT; the number of detected SCIs is smaller than N1; the number of detected HARQ feedbacks is smaller than N2; or the energy sensing at the first terminal device 110 is above a threshold for a period more than z % of the COT.

In some embodiments, the thresholds described above, such as N0, M0, N1, N2, x, y, z, may be pre-defined or be pre-configured by the network device 130.

As such, the first terminal device 110 may perform the CW adjustment based on the input information associated with detected result within the COT which is shared with the multiple terminal devices 120.

It is understood that the first terminal device 110 (CH device) may acquire the COT but is not involved in the SL transmission with any of the multiple terminal devices 120 (CM devices). In other words, there is no logical channel associated with the intended transmission for the first terminal device 110 within the COT. The present disclosure provides a CW adjustment mechanism for the type 1 LBT procedure to facilitate the first terminal device 110 (CH) to share the initiated COT with the multiple terminal devices 120 for SL transmission(s). According to the present disclosure, the first terminal device 110 may adjust the CW based on the input information even without a logical channel associated with the intended transmission within the COT. In some embodiments, the first terminal device 110 and the multiple terminal devices 120 are within the coverage of the network device 130.

FIG. 4B illustrates another example of a process flow 405 in accordance with some example embodiments of the present disclosure. The process flow 405 involves a CH device 401, a first CM device 402 and a second CM device 403. In some embodiments, the process flow 405 may be a specific implementation of the process flow 400 described above. For example, the CH device 401 may be the first terminal device 110, the first CM device 402 may be the terminal device 120-1, and the second CM device 120-2 may be the terminal device 120-2.

In the process flow 405, the CH device 401 determines 4051 a CAPC for a COT sharing with its CM devices, the CM devices includes the first CM device 402 and the second CM device 403. In some examples, the determination at least depends on whether the traffic information of CM devices 402-403 during an anticipated COT is available at the CH device 401.

The CH device 401 acquires 4052 a COT with a CW associated with the determined CAPC. Then the CH device 401 indicates 4053 COT information to its CM devices. In some embodiments, the COT information may be transmitted through (e.g., SCI or sequence-based) control signaling.

In some embodiments, the COT information may indicate the acquired COT. In some other embodiments, the COT information may indicate the acquired COT and the determined CAPC. In some embodiments, the COT information may be shared with the first CM device 402. In some other embodiments, the COT information may be shared with the first CM device 402 and the second CM device 403.

The first CM device 402 determines 4054 traffic type for SL transmission. In some examples, the determination at least based on whether the CAPC is indicated in the COT information.

In some embodiments, if the COT information indicates the acquired COT and the determined CAPC, the traffic type may be determined based on the indicated CAPC. In some other embodiments, if the COT information indicates the acquired COT (without CAPC), the traffic type may be determined based on a default CAPC.

The first CM device 402 and the second CM device 403 perform the SL transmission (e.g., PSCCH/PSSCH 4055 and PSFCH 4056 shown in FIG. 4B) within the COT. In some embodiments, the SL transmission may be based on resource selection and the COT indication. In some embodiments, the SL transmission within the COT may be limited to groupcast and/or unicast transmission.

In the process flow 405, the CH device 401 monitors 4057 the SL transmissions (PSCCH/PSFCH) and/or the channel energy level of the SL transmission. In some embodiments, the CH device 401 may monitor the SL transmission(s) among its CM devices and determine input information for the CW adjustment.

In some alternative embodiments, in case that the CH device 401 and the CM devices 402-403 are in the coverage of a network device (such as gNB), and the SL HARQ feedback is reported to the gNB, the gNB could monitor the results of the HARQ feedback from the CM devices 402-403 and indicate the results to the CH device 401 as part of the input information for CW adjustment.

The CH device 401 further adjusts 4058 the CW based on pre-defined rules and the input information.

It is to be understood that the process 405 shown in FIG. 4B is only for the purpose of illustration without suggesting any limitations.

FIG. 5 illustrates an example of a process flow 500 in accordance with some example embodiments of the present disclosure. For the purpose of discussion, the process flow 500 will be described with reference to FIG. 1A. It would be appreciated that although the process flow 500 has been described in the network environment 100 of FIG. 1A, this process flow may be likewise applied to other communication scenarios.

The process flow 500 involves the first terminal device 110, the terminal device 120-1, the terminal device 120-2 and the network device 130. In some embodiments, the first terminal device 110 may be a CH device, the terminal device 120-1 and the terminal device 120-2 are CM devices in a same cluster. In some embodiments, the terminal device 120-1 may be an initiating device of the SL transmission, and the terminal device 120-2 may be a responding device of the SL transmission.

In the process flow 500, the first terminal device 110 determines 510 a CAPC. Alternatively or in addition, an operation 501 or 505 may be performed before the determination 510.

As shown in FIG. 5, the terminal device 120-1 transmits 502 the traffic information 503 to the first terminal device 110, and the first terminal device 110 receives 504 the traffic information 503. Accordingly, the first terminal device 110 may determine the CAPC based on the traffic information from the terminal device 120-1.

As shown in FIG. 5, the network device 130 transmits 508 an initiating command 509 to the first terminal device 110. Alternatively or in addition, the terminal device 120-1 may transmit 506 the traffic information 503 to the network device 130, and the network device 130 receives 507 the traffic information 503.

In some embodiments, the initiating command 509 may be carried in an RRC message or RRC signaling. In some other embodiments, the initiating command 509 may be carried in another message and the present disclosure does not limit this aspect.

In some example embodiments, the initiating command 509 is used for indicating the first terminal device 110 to initiate a COT. In some example embodiments, the initiating command may include one or more of: the CAPC, multiple identifiers of multiple terminal devices, traffic information, or timing information for initiating the COT.

In some examples, the network device 130 may determine the CAPC according to the cluster configuration. In some examples, the network device 130 may determine the CAPC based on the traffic information from the terminal device 120-1.

In some examples, multiple terminal devices may be grouped in one or more clusters. For example, as shown in FIG. 1B, the terminal device 120-1 and the terminal device 120-2 belong to a same cluster, the terminal device 120-3, the terminal device 120-4 and the terminal device 120-5 belong to another cluster.

In some embodiments, it is assumed that there will be an SL transmission from the terminal device 120-1 to the terminal device 120-2, thus the initiating command 509 may include an identifier of the terminal device 120-1 and an identifier of the terminal device 120-2. In some examples, the initiating command 509 may also indicate that the terminal device 120-1 is an initiating device of the SL transmission and the terminal device 120-2 is a responding device of the SL transmission.

It is to be understood that, in some other embodiments, if there will be a first SL transmission from the terminal device 120-1 to the terminal device 120-2 and a second SL transmission from the terminal device 120-3 to the terminal device 120-4 (as shown in FIG. 1C), the initiating command 509 may further indicate that the terminal device 120-1 and the terminal device 120-2 belong to a same cluster, the terminal device 120-3, the terminal device 120-4 and the terminal device 120-5 belong to another cluster.

In some examples, the initiating command 509 may include traffic information associated with the terminal device 120-1 and/or the terminal device 120-2. It is to be understood that, in some other embodiments, the initiating command 509 may further include another traffic information associated with the terminal device 120-3 and/or the terminal device 120-4.

In some examples, the initiating command 509 may include timing information for initiating the COT. For examples, the timing information may indicate an initiating time, as such, the first terminal device 110 may initiate the COT at the initiating time. For example, the timing information may indicate an initiating periodicity, as such, the first terminal device 110 may re-initiate the COT after a previous initiating based on a time period of the initiating periodicity expires.

On the other side of communication, the first terminal device 110 receives 5091 the initiating command 509. In some examples, if the initiating command 509 includes the CAPC, the first terminal device 110 may determine 510 the CAPC by obtaining it from the initiating command 509. In some other examples, if the initiating command 509 does not include the CAPC but includes the traffic information, the first terminal device 110 may determine 510 the CAPC based on the traffic information. In some other examples, if the initiating command 509 does not include the CAPC or the traffic information, the first terminal device 110 may determine 510 the CAPC itself, for example, a predefined CAPC, which may be a lowest or a highest CAPC among multiple pre-configured CAPCs, or based on the traffic information 503 received at 504.

The first terminal device 110 initiates 520 a COT by performing an LBT procedure associated with a CAPC. In some embodiments, the LBT procedure may be a type 1 LBT procedure, or also be called as a type 1 LBT. In some embodiments, the first terminal device 100 may initiate the COT based on the initiating command 509 from the network device 130.

In some embodiments, the initiating command 509 includes timing information for initiating the COT, and the first terminal device 110 may initiate 520 the COT based on the timing information. For example, the first terminal device 110 may initiate the COT at an initiating time indicated by the timing information. For example, the timing information may indicate an initiating periodicity, and the first terminal device 110 may re-initiate the COT after a previous initiating based on a time period of the initiating periodicity expires.

The first terminal device 110 transmits 530 an indication of the COT 531 to the multiple terminal devices 120, including terminal device 120-1 and terminal device 120-2 as shown in FIG. 5. As such, the terminal device 120-1 may receive 532 the indication of the COT 531, and the terminal device 120-2 may receive 534 the indication of the COT 531. Alternatively or in addition, the first terminal device 110 may transmit an indication of the CAPC to the multiple terminal devices 120.

In some examples, the first terminal device 110 may determine that the target terminal devices of the indication of the COT include the terminal device 120-1 and terminal device 120-2, based on the initiating command 509. For example, the initiating command 509 may include identifiers of the terminal device 120-1 and terminal device 120-2.

The terminal device 120-1 determines 536 traffic type of the SL transmission based on the CAPC. The terminal device 120-1 transmits 540 the SL transmission 542 to the terminal device 120-2 during the COT. On the other side of communication, the terminal device 120-2 receives 544 the SL transmission 542. The terminal device 120-2 transmits 550 feedback information 552 of the SL transmission to the terminal device 120-1. Accordingly, the terminal device 120-1 receives 554 the feedback information 552.

It is to be understood that the processes 520-554 may refer to those described with reference to FIG. 4A, and thus will not be repeated herein.

As shown in FIG. 5, the network device 130 monitors 560 feedback information transmitted by the terminal device 120-2. And the network device 130 transmits 570 the feedback information 572 to the first terminal device 110, accordingly the first terminal device 110 receives the feedback information 572.

The first terminal device 110 detects 580 the SL transmission during the COT. In some example embodiments, the first terminal device 110 may detect the SL transmission and determine a detection result. In some example embodiments, the detection result may include one or more of: SCI associated with the SL transmission, or a channel energy level of the SL transmission.

Alternatively or in addition, the first terminal device 110 may determine input information at least based on the detection result or the feedback information 572 from the network device 130, where the input information may be used for CW adjustment.

The first terminal device 110 performs 590 a CW adjustment based on the input information. In some embodiments, the first terminal device 110 may adjust the CW associated with the CAPC according to at least one pre-defined rules.

It is to be understood that the similar operations in FIG. 5 may refer to those described with reference to FIG. 4A. Although the embodiments are described with reference to FIGS. 4A-5 respectively, it is to be understood that some operations may be combined in some other embodiments. For example, the first terminal device 110 may initiate the COT based on an initiating command from the network device 130 in FIG. 4A. For another example, the first terminal device 110 may receive timing information from the network device 130 and receive traffic information from the terminal device 120-1 in FIG. 5. The present disclosure does not limit this aspect.

In a specific example, with reference to FIG. 1C, it is assumed that the network device 130 may configure a first terminal device 110 as a CH device and multiple terminal devices 120-1 to 120-5 as CM devices. The first terminal device 110 may be responsible for COT initiation and sharing with the multiple terminal devices 120-1 to 120-5. In some examples, the multiple terminal devices 120-1 to 120-5 are within the coverage of the first terminal device 110, so that the first terminal device 110 can successfully share its initiated COT with the multiple terminal devices 120-1 to 120-5, and the first terminal device 110 can detect the SL transmission among the multiple terminal devices 120-1 to 120-5 based on identifiers of the multiple terminal devices 120-1 to 120-5.

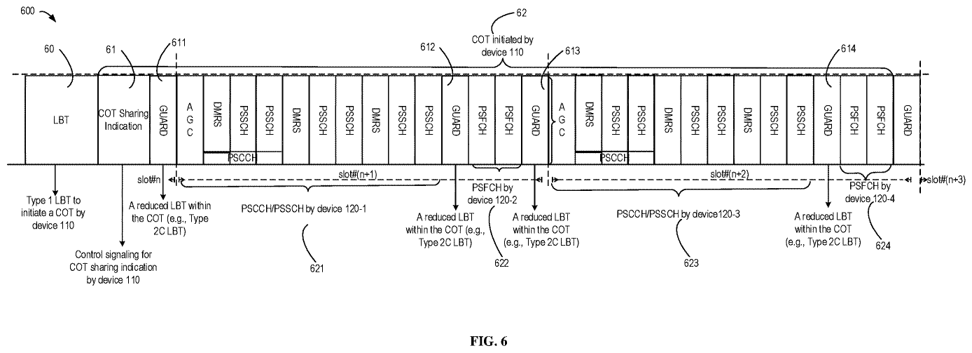

It is assumed that there is an SL transmission between the terminal device 120-1 and the terminal device 120-2, and another SL transmission between the terminal device 120-3 and the terminal device 120-4. FIG. 6 illustrates an example frame structure 600 in accordance with some example embodiments of the present disclosure.

In some embodiments, the first terminal device 110 may determine anticipated terminal devices based on BSR, for example, the anticipated terminal devices include the terminal devices 120-1 to 120-4.

The first terminal device 110 would perform a type 1 LBT procedure 60 at slot #n. If the first terminal device 110 successfully acquires the channel, it would initiate a COT 62 with a duration of 30 OFDM symbols and share 61 the COT to the terminal devices 120-1 to 120-4 for SL transmission. For example, the first terminal device 110 transmits control signaling (e.g. through a sequence) to indicate the COT over two OFDM symbols 61 within the COT 52 (i.e., OFDMA Symbol #11/12 in the slot #n). In some examples, the indication of the COT may at least be able to inform the terminal devices 120-1 to 120-4 whether a COT is acquired in the subsequent slot(s).

The terminal device 120-1 and the terminal device 120-3 are intended to perform an SL transmission respectively. Thus the terminal device 120-1 and the terminal device 120-3 may perform a reduced LBT (e.g., Type 2C LBT) in the second guard symbol of slot #n and slot #(n+1) (shown as 611 and 613 in FIG. 6) to access the channel, respectively. Accordingly, the terminal device 120-1 may transmit PSCCH/PSSCH 621 to the terminal device 120-2 in slot #(n+1) within the COT. The terminal device 120-3 may transmit PSCCH/PSSCH 623 to the terminal device 120-4 in slot #(n+2) within the COT.

The terminal device 120-2 and the terminal device 120-4 may perform a reduced LBT (e.g., Type 2C LBT) in the first guard symbol of slot #(n+1) and slot #(n+2) (shown as 612 and 614 in FIG. 6) to access the channel, respectively. Accordingly, the terminal device 120-2 transmit PSFCH 622 to the terminal device 120-1 for HARQ feedback in slot #(n+1) within the COT. The terminal device 120-4 transmit PSFCH 624 to the terminal device 120-3 for HARQ feedback in slot #(n+2) within the COT.

It is to be understood that the reduced LBT may be implemented in the guard symbol by CP extension like in NR-U and the present disclosure does not limit this aspect. Additionally, the SL transmission during the COT may be a groupcast or unicast SL transmission, thus either groupcast or unicast SL transmission is allowed in different sub-bands.

In this example, the CH can decide on how to adjust the CW size e.g. based on the SCI on PSCCH or HARQ feedback on PSFCH (i.e. PSSCH or PSFCH is the reference resource for CW adjustment). Alternatively, the CH may just detect channel energy e.g during the AGC symbol DMRS, or PSFCH. Yet further option is that the CH performs detection of the DMRS sequences transmitted by the CMs.

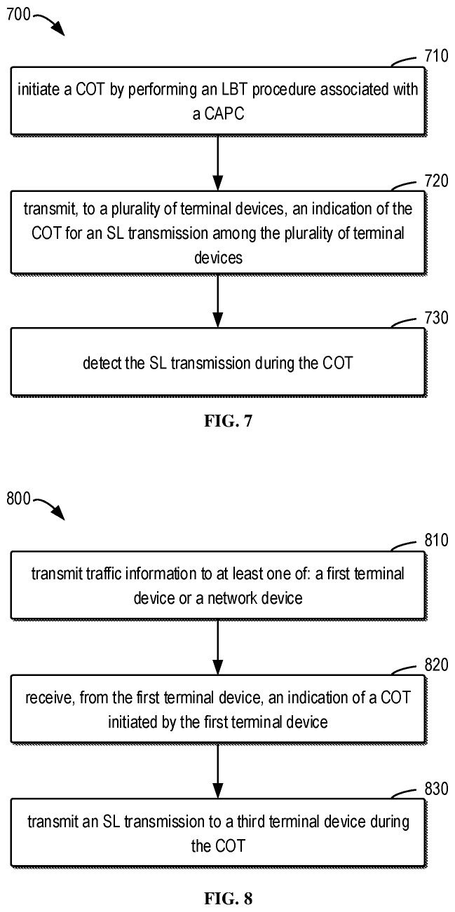

FIG. 7 illustrates a flowchart 700 of a method implemented at a first terminal device in accordance with some example embodiments of the present disclosure. For the purpose of discussion, the method 700 will be described from the perspective of the first terminal device 110 with reference to FIG. 1A.

At block 710, the first terminal device 110 initiates a channel occupancy time (COT) by performing a Listen Before Talk (LBT) procedure associated with a channel access priority class (CAPC). At block 720, the first terminal device 110 transmits, to multiple terminal devices 120, an indication of the COT for a sidelink (SL) transmission among the multiple terminal devices 120. At block 730, the first terminal device 110 detects the SL transmission during the COT.

In some example embodiments, the first terminal device 110 receives, from a network device 130, an initiating command indicating the first terminal device to initiate the COT, the initiating command comprising at least one of: the CAPC, a plurality of identifiers of the plurality of terminal devices, traffic information of the SL transmission, or timing information for initiating the COT.

In some example embodiments, the first terminal device 110 receives traffic information of the SL transmission from one of the multiple terminal devices 120; and determines the CAPC based on the traffic information.

In some example embodiments, the traffic information indicates a traffic type associated with categories of the multiple terminal devices 120.

In some example embodiments, the first terminal device 110 determines the CAPC to be a predefined CAPC, the predefined CAPC being a lowest CAPC or a highest CAPC from multiple pre-configured CAPCs.

In some example embodiments, the first terminal device 110 determines the CAPC to be a highest CAPC from multiple pre-configured CAPCs.

In some example embodiments, the first terminal device 110 transmits an indication of the CAPC to the multiple terminal devices 120.

In some example embodiments, the first terminal device 110 determines input information at least based on a detection result of the SL transmission during the COT; and performs a contention window (CW) adjustment at least partially based on the input information.

In some example embodiments, the detection result of the SL transmission comprises at least one of: sidelink control information (SCI) associated with the SL transmission, HARQ feedback information of the SL transmission, or a channel energy level of the SL transmission.

In some example embodiments, the first terminal device 110 detects a resource allocation of the SL transmission within the COT; and monitors the HARQ feedback information based on the resource allocation.

In some example embodiments, the first terminal device 110 detects the channel energy level by sensing a channel at a predetermined time.

In some example embodiments, the first terminal device 110 receives the HARQ feedback information from a network device 130, the first terminal device 110 and the multiple terminal devices 120 are within a coverage of the network device 130.

In some example embodiments, the first terminal device 110 resets a size of the CW to an initial value based on at least one of: a number of acknowledges (ACKs) indicated by the HARQ feedback information exceeding a threshold of ACK number, a ratio of the number of ACKs to a total feedback number indicated by the HARQ feedback information exceeding a threshold of ACK ratio, a number of terminal devices transmitting the SCI exceeding a threshold of device number, or a ratio of the number of terminal devices transmitting the SCI to a number of the multiple terminal devices 120 exceeding a threshold of device ratio.

In some example embodiments, the HARQ feedbacks are determined based on a change of detected channel energies before and after a predefined time within the COT exceeding a threshold of energy detection.

In some example embodiments, the first terminal device 110 increases a size of the CW based on at least one of: no SCI being detected, no HARQ feedback being detected, a number of detected SCIs being below a threshold of SCIs, a number of detected HARQ feedbacks being below a threshold of feedback, or a ratio of a time period in which the channel energy level is above a threshold to the COT exceeding a threshold of time ratio.

FIG. 8 illustrates a flowchart 800 of a method implemented at a second terminal device in accordance with some example embodiments of the present disclosure. For the purpose of discussion, the method 800 will be described from the perspective of one of the multiple terminal devices 120 (such as a second terminal device 120-1) with reference to FIG. 1A.

At block 810, the second terminal device 120-1 transmits traffic information to at least one of: a first terminal device 110 or a network device 130. At block 820, the second terminal device 120-1 receives, from the first terminal device 110, an indication of a channel occupancy time (COT) initiated by the first terminal device 110. At block 830, the second terminal device 120-1 transmits a sidelink (SL) transmission to a third terminal device 120-2 during the COT.

In some example embodiments, the traffic information indicates a traffic type associated with categories of multiple terminal devices 120 comprising the second terminal device 120-1 and the third terminal device 120-2.

In some example embodiments, the second terminal device 120-1 receives, from the first terminal device 110, an indication of a channel access priority class (CAPC).

In some example embodiments, the second terminal device 120-1 determines a default CAPC configured by the network device 130 if an indication of CAPC is not received from the first terminal device 110.

In some example embodiments, the second terminal device 120-1 determines the SL transmission with a traffic type based on the CAPC.

In some example embodiments, the second terminal device 120-1 receives, from the third terminal device 120-2, hybrid automatic repeat request (HARQ) feedback information of the SL transmission within the COT.

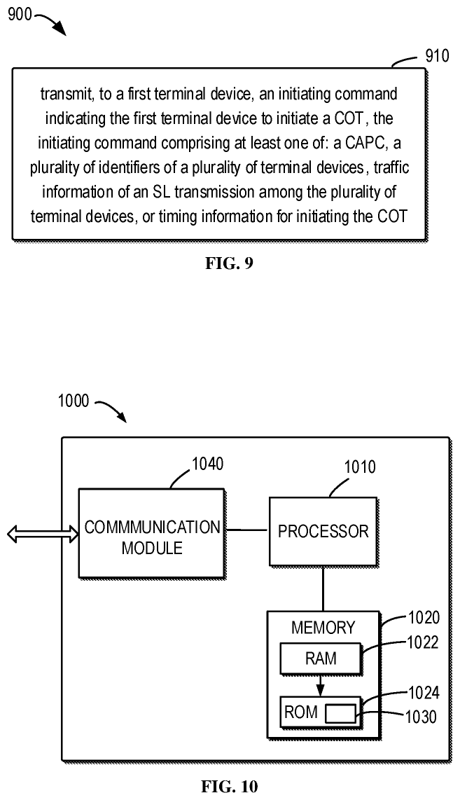

FIG. 9 illustrates a flowchart 900 of a method implemented at a network device in accordance with some other embodiments of the present disclosure. For the purpose of discussion, the method 900 will be described from the perspective of the network device 130 with reference to FIG. 1A.

At block 910, the network device 130 transmits, to a first terminal device 110, an initiating command indicating the first terminal device to initiate a COT, the initiating command comprising at least one of: a CAPC, a plurality of identifiers of a plurality of terminal devices, traffic information of an SL transmission among the plurality of terminal devices, or timing information for initiating the COT.

In some example embodiments, the network device 130 receives, from the second terminal device 120-1, traffic information of the SL transmission between the second terminal device and a third terminal device, the plurality of terminal devices comprising the second terminal device and third terminal device.

In some example embodiments, the traffic information indicates a traffic type associated with categories of the second terminal device and third terminal device.

In some example embodiments, the network device 130 monitors feedback information transmitted by a third terminal device 120-2 to a second terminal device 120-1, the feedback information is provided for the SL transmission from the second terminal device 120-1 to the third terminal device 120-2, the SL transmission is transmitted during the COT initiated by a first terminal device 110, the plurality of terminal devices comprises the second terminal device and third terminal device. Then the network device 130 transmits the feedback information to the first terminal device 110.

In some example embodiments, the feedback information comprises hybrid automatic repeat request (HARQ) feedback information.

In some example embodiments, an apparatus capable of performing the method 700 (for example, the first terminal device 110) may comprise means for performing the respective steps of the method 700. The means may be implemented in any suitable form. For example, the means may be implemented in a circuitry or software module.

In some example embodiments, the apparatus comprises: means for initiating, at a first terminal device, a channel occupancy time (COT) by performing a Listen Before Talk (LBT) procedure associated with a channel access priority class (CAPC); means for transmitting, to multiple terminal devices, an indication of the COT for a sidelink (SL) transmission among the multiple terminal devices; and means for detecting the SL transmission during the COT.

In some example embodiments, the apparatus comprises: means for receiving, from a network device, an initiating command indicating the first terminal device to initiate the COT, the initiating command comprising at least one of: the CAPC, a plurality of identifiers of the plurality of terminal devices, traffic information of the SL transmission, or timing information for initiating the COT.

In some example embodiments, the apparatus comprises: means for receiving traffic information of the SL transmission from one of the plurality of terminal devices; and means for determining the CAPC based on the traffic information.

In some example embodiments, the traffic information indicates a traffic type associated with categories of the multiple terminal devices.

In some example embodiments, the apparatus comprises: means for determining the CAPC to be a predefined CAPC, the predefined CAPC being a lowest CAPC or a highest CAPC from a plurality of pre-configured CAPCs.

In some example embodiments, the apparatus comprises: means for determining the CAPC to be a highest CAPC from a plurality of pre-configured CAPCs.

In some example embodiments, the apparatus comprises: means for transmitting an indication of the CAPC to the plurality of terminal devices.

In some example embodiments, the apparatus comprises: means for determining input information at least based on a detection result of the SL transmission during the COT; and means for performing a contention window (CW) adjustment at least partially based on the input information.

In some example embodiments, the detection result of the SL transmission comprises at least one of: sidelink control information (SCI) associated with the SL transmission, hybrid automatic repeat request (HARQ) feedback information of the SL transmission, or a channel energy level of the SL transmission.

In some example embodiments, the apparatus comprises: means for detecting a resource allocation of the SL transmission within the COT; and means for monitoring the HARQ feedback information based on the resource allocation.

In some example embodiments, the apparatus comprises: means for detecting the channel energy level by sensing a channel at a predetermined time.

In some example embodiments, the apparatus comprises: means for receiving the HARQ feedback information from a network device, the first terminal device and the plurality of terminal devices are within a coverage of the network device.

In some example embodiments, the apparatus comprises: means for resetting a size of the CW to an initial value based on at least one of: a number of acknowledges (ACKs) indicated by the HARQ feedback information exceeding a threshold of ACK number, a ratio of the number of ACKs to a total feedback number indicated by the HARQ feedback information exceeding a threshold of ACK ratio, a number of terminal devices transmitting the SCI exceeding a threshold of device number, or a ratio of the number of terminal devices transmitting the SCI to a number of the plurality of terminal devices exceeding a threshold of device ratio.

In some example embodiments, the HARQ feedbacks are determined based on a change of detected channel energies before and after a predefined time within the COT exceeding a threshold of energy detection.

In some example embodiments, the apparatus comprises: means for increasing a size of the CW based on at least one of: no SCI being detected, no HARQ feedback being detected, a number of detected SCIs being below a threshold of SCIs, a number of detected HARQ feedbacks being below a threshold of feedback, or a ratio of a time period in which the channel energy level is above a threshold to the COT exceeding a threshold of time ratio.

In some example embodiments, the apparatus further comprises means for performing other steps in some example embodiments of the method 700. In some example embodiments, the means comprises at least one processor; and at least one memory including computer program code, the at least one memory and computer program code configured to, with the at least one processor, cause the performance of the apparatus.

In some example embodiments, an apparatus capable of performing the method 800 (for example, the second terminal device 120-1) may comprise means for performing the respective steps of the method 800. The means may be implemented in any suitable form. For example, the means may be implemented in a circuitry or software module.

In some example embodiments, the apparatus comprises: means for transmitting, at a second terminal device, traffic information to at least one of: a first terminal device or a network device; means for receiving, from the first terminal device, an indication of a channel occupancy time (COT) initiated by the first terminal device; and means for transmitting a sidelink (SL) transmission to a third terminal device during the COT.

In some example embodiments, the traffic information indicates a traffic type associated with categories of a plurality of terminal devices comprising the second terminal device and the third terminal device.

In some example embodiments, the apparatus comprises: means for receiving, from the first terminal device, an indication of a channel access priority class (CAPC).

In some example embodiments, the apparatus comprises: means for determining a default CAPC configured by the network device if an indication of CAPC is not received from the first terminal device.

In some example embodiments, the apparatus comprises: means for determining the SL transmission with a traffic type based on the CAPC.

In some example embodiments, the apparatus comprises: means for receiving, from the third terminal device, hybrid automatic repeat request (HARQ) feedback information of the SL transmission within the COT.

In some example embodiments, the apparatus further comprises means for performing other steps in some example embodiments of the method 800. In some example embodiments, the means comprises at least one processor; and at least one memory including computer program code, the at least one memory and computer program code configured to, with the at least one processor, cause the performance of the apparatus.

In some example embodiments, an apparatus capable of performing the method 900 (for example, the network device 130) may comprise means for performing the respective steps of the method 900. The means may be implemented in any suitable form. For example, the means may be implemented in a circuitry or software module.

In some example embodiments, the apparatus comprises: means for transmitting, to a first terminal device, an initiating command indicating the first terminal device to initiate a COT, the initiating command comprising at least one of: a CAPC, a plurality of identifiers of a plurality of terminal devices, traffic information of an SL transmission among the plurality of terminal devices, or timing information for initiating the COT.

In some example embodiments, the apparatus comprises: means for receiving, from the second terminal device, traffic information of the SL transmission between the second terminal device and a third terminal device, the plurality of terminal devices comprising the second terminal device and third terminal device.

In some example embodiments, the traffic information indicates a traffic type associated with categories of the second terminal device and third terminal device.

In some example embodiments, the apparatus comprises: means for monitoring, at a network device, feedback information transmitted by a third terminal device to a second terminal device, the feedback information being provided for the SL transmission from the second terminal device to the third terminal device, the SL transmission being transmitted during the COT initiated by a first terminal device, the plurality of terminal devices comprises the second terminal device and third terminal device; and means for transmitting the feedback information to the first terminal device.

In some example embodiments, the feedback information comprises hybrid automatic repeat request (HARQ) feedback information.

In some example embodiments, the apparatus further comprises means for performing other steps in some example embodiments of the method 900. In some example embodiments, the means comprises at least one processor; and at least one memory including computer program code, the at least one memory and computer program code configured to, with the at least one processor, cause the performance of the apparatus.

FIG. 10 illustrates a simplified block diagram of a device 1000 that is suitable for implementing some example embodiments of the present disclosure. The device 1000 may be provided to implement the communication device, for example the first terminal device 110, any of the terminal devices 120, or the network device 130 as shown in FIG. 1A. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any process of the disclosure as discussed with reference to FIGS. 4A to 9. The embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like.

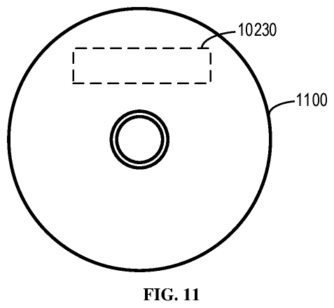

FIG. 11 illustrates a block diagram of an example of a computer readable medium 1100 in accordance with some example embodiments of the present disclosure. The computer readable medium 1100 has the program 1030 stored thereon. It is noted that although the computer readable medium 1100 is depicted in form of CD or DVD in FIG. 11, the computer readable medium 1100 may be in any other form suitable for carry or hold the program 1030.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 7-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-32. (canceled)

33. A first terminal device comprising:
at least one processor; and
at least one memory storing instructions that, when executed by the at least one processor, cause the first terminal device at least to:
initiate a channel occupancy time (COT) by performing a Listen Before Talk (LBT) procedure associated with a channel access priority class (CAPC);
transmit, to a plurality of terminal devices, an indication of the COT for a sidelink (SL) transmission among the plurality of terminal devices; and
detect the SL transmission during the COT.

34. The first terminal device of claim 33, wherein the first terminal device is further caused to:
receive, from a network device, an initiating command indicating the first terminal device to initiate the COT, the initiating command comprising at least one of:
the CAPC,
a plurality of identifiers of the plurality of terminal devices,
traffic information of the SL transmission, or
timing information for initiating the COT.

35. The first terminal device of claim 33, wherein the first terminal device is further caused to:
receive traffic information of the SL transmission from one of the plurality of terminal devices; and
determine the CAPC based on the traffic information.

36. The first terminal device of claim 34, wherein the traffic information indicates a traffic type associated with categories of the plurality of terminal devices.

37. The first terminal device of claim 33, wherein the first terminal device is further caused to:
determine the CAPC to be a predefined CAPC, the predefined CAPC being a lowest CAPC or a highest CAPC from a plurality of pre-configured CAPCs.

38. The first terminal device of claim 33, wherein the first terminal device is further caused to:
transmit an indication of the CAPC to the plurality of terminal devices.

39. The first terminal device of claim 33, wherein the first terminal device is further caused to:
determine input information at least based on a detection result of the SL transmission during the COT; and
perform a contention window (CW) adjustment at least partially based on the input information.

40. The first terminal device of claim 39, wherein the detection result of the SL transmission comprises at least one of:
sidelink control information (SCI) associated with the SL transmission,
hybrid automatic repeat request (HARQ) feedback information of the SL transmission, or
a channel energy level of the SL transmission.

41. The first terminal device of claim 40, wherein the first terminal device is further caused to:
detect a resource allocation of the SL transmission within the COT; and
monitor the HARQ feedback information based on the resource allocation.

42. The first terminal device of claim 40, wherein the first terminal device is further caused to:
detect the channel energy level by sensing a channel at a predetermined time.

43. The first terminal device of claim 40, wherein the first terminal device is further caused to:
receive the HARQ feedback information from a network device, the first terminal device and the plurality of terminal devices are within a coverage of the network device.

44. The first terminal device of claim 39, wherein the first terminal device is caused to perform the CW adjustment by:
resetting a size of the CW to an initial value based on at least one of:
a number of acknowledges (ACKs) indicated by the HARQ feedback information exceeding a threshold of ACK number,
a ratio of the number of ACKs to a total feedback number indicated by the HARQ feedback information exceeding a threshold of ACK ratio,
a number of terminal devices transmitting the SCI exceeding a threshold of device number, or
a ratio of the number of terminal devices transmitting the SCI to a number of the plurality of terminal devices exceeding a threshold of device ratio.

45. The first terminal device of claim 44, wherein the HARQ feedbacks are determined based on a change of detected channel energies before and after a predefined time within the COT exceeding a threshold of energy detection.

46. The first terminal device of claim 39, wherein the first terminal device is caused to perform the CW adjustment by:
increasing a size of the CW based on at least one of:
no SCI being detected,
no HARQ feedback being detected,
a number of detected SCIs being below a threshold of SCIs,
a number of detected HARQ feedbacks being below a threshold of feedback, or
a ratio of a time period in which the channel energy level being above a threshold to the COT exceeding a threshold of time ratio.

47. A second terminal device comprising:
at least one processor; and
at least one memory storing instructions that, when executed by the at least one processor, cause the first terminal device at least to:
transmit traffic information to at least one of: a first terminal device or a network device;
receive, from the first terminal device, an indication of a channel occupancy time (COT) initiated by the first terminal device; and
transmit a sidelink (SL) transmission to a third terminal device during the COT.

48. The second terminal device of claim 47, wherein the second terminal device is further caused to:
receive, from the first terminal device, an indication of a channel access priority class (CAPC).

49. The second terminal device of claim 47, wherein the second terminal device is further caused to:
in accordance with a determination that an indication of CAPC is not received from the first terminal device, determine a default CAPC configured by the network device.

50. The second terminal device of claim 48, wherein the second terminal device is further caused to:
determine the SL transmission with a traffic type based on the CAPC.

51. The second terminal device of claim 47, wherein the second terminal device is further caused to:
receive, from the third terminal device, hybrid automatic repeat request (HARQ) feedback information of the SL transmission within the COT.

52. A method, comprising:
initiating, at a first terminal device, a channel occupancy time (COT) by performing a Listen Before Talk (LBT) procedure associated with a channel access priority class (CAPC);
transmitting, to a plurality of terminal devices, an indication of the COT for a sidelink (SL) transmission among the plurality of terminal devices; and
detecting the SL transmission during the COT.
